(19) United States
(12) Patent Application Publication
(10) Pub. No.: US 2014/0375811 A1
(43) Pub. Date: Dec. 25, 2014

(54) DEVICE AND METHOD FOR OPERATING A DISPLAY DEVICE SITUATED ALONG A STREET, AND CORRESPONDING VEHICLE SYSTEM

(71) Applicant: Stefan Nordbruch, Kornwestheim (DE)

(72) Inventor: Stefan Nordbruch, Kornwestheim (DE)

(21) Appl. No.: 14/343,330

(22) PCT Filed: Jul. 16, 2012
(86) PCT No.: PCT/EP2012/063910

§ 371 Date: Jun. 23, 2014

(30) Foreign Application Priority Data
Sep. 9, 2011 (DE) 10 2011 082 403.0

(51) Int. Cl. H04N 7/18; G06K 9/00

(52) U.S. Cl. CPC H04N 7/181; G06K 9/00785
USPC 348/148

(57) ABSTRACT

A device for operating a display device located on a road includes: a determination device for determining when a vehicle is entering a visual range of the display device; and a control for controlling the display device as a function of a result of the determination.

### BACKGROUND OF THE INVENTION

1. Field of the Invention

The present invention relates to a device and a method for operating a display device situated along a street. Moreover, the present invention relates to a vehicle, a display system and a computer program.

2. Description of the Related Art

Screens for the display of information on public information devices, especially for the display of advertising information, are known per se, for instance from the German utility model patent DE 20 2006 003 259 U1. Such a screen consumes energy when in use, regardless of whether a person is present within the visual range of the screen. In other words, if no person is located within the visual range of the screen, electrical energy is consumed anyway, which generally is not useful.

### BRIEF SUMMARY OF THE INVENTION

The object on which the present invention is based thus is to make available a device for operating a display device situated along a road which allows the display device to be operated in an energy-efficient manner.

The object on which the present invention is based may also be seen as providing a corresponding method for operating a display device situated on a road.

The object on which the present invention is based may also be seen as providing a corresponding vehicle, a corresponding display system, and a corresponding computer program.

According to one aspect, a device is provided for operating a display device located on a road. The device includes a determination device for determining when a vehicle is moving into a visual range of the display device. In addition, the device includes a control for controlling the display device, the control of the display device being implemented as a function of a result of the determination.

According to another aspect, a method for operating a display device located on a road is provided. It is determined when a vehicle moves into a visual range of the display device. The display device is controlled as a function of the result of the determination.

According to another aspect, a vehicle system for a vehicle is provided, which includes a transmitter for transmitting a vehicle position and a vehicle speed to a control for controlling a display device situated on a road.

According to a still further aspect, a display system is provided, which includes a display device which is able to be placed on a road, and a device for operating a display device situated on a road.

According to a still further aspect, a computer program is provided, which includes program code to execute the method for operating a display device located on a road when the computer program is running on a computer, especially a control.

In other words, the present invention encompasses the idea of determining when a vehicle is entering a visual range of the display device, which means, in particular, that it is determined when the vehicle enters the visual range or arrives in the visual range of the display device. The display is controlled as a function of the result of the determination, that is to say, especially as a function of the instant at which the vehicle is entering the visual range. This advantageously allows an especially energy-efficient operation of the display device, inasmuch as the display device, for example, may be transferred into an operating state in which barely any or no current at all is used if the vehicle is not yet located within the visual range of the display device. It may be provided that the device is activated only after the vehicle enters the visual range of the display device, in particular.

A control of the display device within the meaning of the present invention especially includes an activation and deactivation of the display device. An activated display device in particular displays information, such as advertising information. A deactivated display device shows no information, in particular. A deactivation of the display device may include a complete deactivation of the display device, so that the deactivated display device uses no more electricity. However, it may in particular also be the case that a deactivation of the display device includes transferring the display device into a standby operating mode. Controlling the display device in particular may also include controlling a brightness of the displayed information. Since generally less electrical energy is used when the information is displayed at a reduced brightness, it thus is advantageously possible to save energy in this way as well. A control of the display device in particular may also encompass the step of deciding which information is displayed.

Specifically, controlling the display device may also include the step of deciding for how long the information will be displayed.

A visual range of the display device within the meaning of the present invention in particular denotes a range in which visual contact exists between the vehicle or the vehicle occupants and the display device. That is to say, it means especially that a vehicle passenger located in the visual range is able to see the display device and therefore is also able to see the displayed information. The phrase “when a vehicle is moving into a visual range of the display device” in particular describes the instant when the vehicle enters the visual range of the display device, i.e., especially when the vehicle or the vehicle occupants are able to see the display device.

According to one specific embodiment, the determination device includes a detection device for detecting a vehicle position and a vehicle speed. That is to say, a vehicle position and a vehicle speed, in particular, are detected in order to advantageously determine when the vehicle is moving into the visual range of the display device. Especially the current vehicle position and/or the current vehicle speed are/is recorded in the process. If the current vehicle position is known, a distance still to be driven by the vehicle on the road in order to enter the visual range of the display device is able to be calculated. If the vehicle speed is known in addition, it may be used to determine the instant when the vehicle is moving into the visual range of the display device.

According to one specific embodiment, it may be the case that the detection device includes a radar sensor and/or a laser sensor for detecting a vehicle position and/or a vehicle speed. If the determination device is located inside a vehicle, it may in particular be provided that the determination device includes a navigation system. Such a navigation system may be equipped with a global positioning sensor (GPS), for instance. For example, the detection device could be situated along a road, in particular.

According to one specific embodiment, a database is formed, which holds person-specific information. In addition, the control is developed in such a way that it controls the display device as a function of the person-specific information. This advantageously makes it possible for the display device to display person-specific information, so that information, especially advertising information, is able to be provided to a vehicle passenger in a manner that is personally optimized and selective.

In another specific embodiment, the vehicle position and the vehicle speed, especially the current vehicle position and the current vehicle speed of the vehicle, are transmitted from the vehicle to the determination device.

According to a further specific embodiment, it may be the case that a scheduled driving route of the vehicle is transmitted from the vehicle to the determination device. This advantageously allows an even more precise determination of the instant when the vehicle is moving into the visual range of the display device. While it is true that the current vehicle position and the current vehicle speed may be used to calculate the instant at which the vehicle moves into the visual range, this calculation in particular assumes that the vehicle will maintain its current vehicle speed. However, if the vehicle still is to drive on route sections that have a lower permitted maximum speed than the current vehicle speed, it may be assumed that the vehicle will drive through these route sections at a lower speed, which then is advantageously able to be taken into account when the instant is determined at which the vehicle moves into the visual range of the display device. Possible detours or rest breaks of the vehicle may be considered as well. In particular if the vehicle selects a fork that no longer leads to the display device, the display device may be controlled to the extent that it will not be activated because it was determined that the vehicle is not moving into the visual range of the display device. The scheduled driving route is able to be provided with the aid of a navigation system, for instance.

According to another specific embodiment, information specific to the vehicle passenger and/or the vehicle is transmitted from the vehicle to the control. The display device then is controlled in particular as a function of the transmitted information. This in turn advantageously makes it possible for the display device to provide specific information, especially advertising, in accordance with the transmitted information.

In another specific embodiment, an identification device for identifying vehicle passengers is provided. The transmitter is developed specifically for the purpose of transmitting identification data of the vehicle passengers to the control. Therefore, it is advantageously possible for the display device to display person-specific information, especially advertising, to the vehicle occupant(s). For example, an identification device may include a fingerprint reader and/or a scanner for the iris of an eye. However, it may also be the case that the vehicle occupants identify themselves by means of a transponder on a vehicle key at the identification device.

The present invention will be explained in greater detail in the following text with reference to preferred exemplary embodiments.

### BRIEF DESCRIPTION OF THE DRAWINGS

FIG. 1 shows a device for operating a display device located on a road.

FIG. 2 shows a flow chart of a method for operating a display device located on a road.

FIG. 3 shows a flow chart of another method for operating a display device located on a road.

FIG. 4 shows a vehicle system for a vehicle.

FIG. 5 shows a display system.

FIG. 6 shows a vehicle that transmits its current vehicle position and its current vehicle speed to an external control server.

### DETAILED DESCRIPTION OF THE INVENTION

In the following text, the same reference numerals are used for the same features.

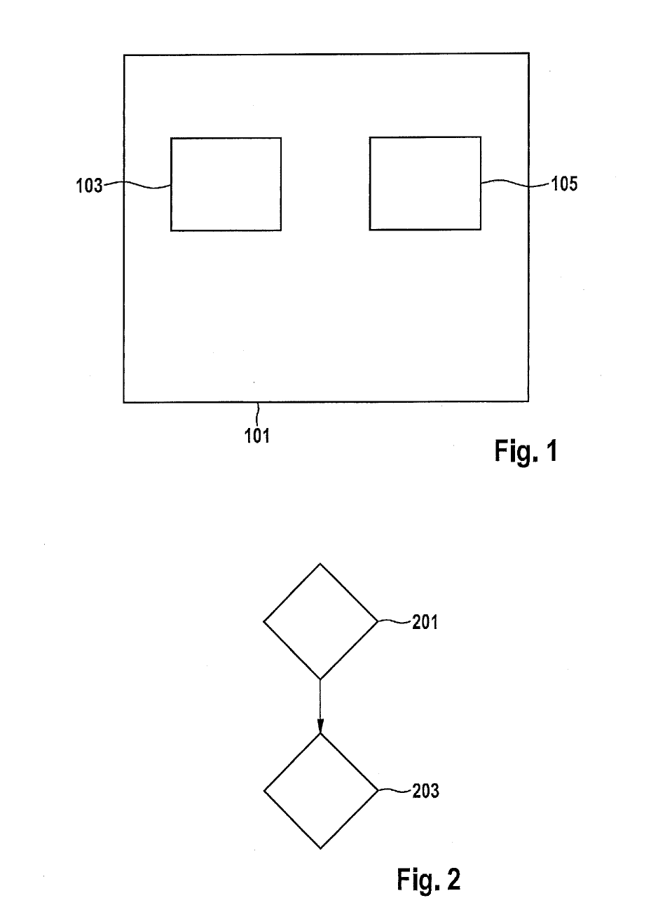

FIG. 1 shows a device 101 for operating a display device (not shown) located on a road. Device 101 includes a determination device 103 to determine when a vehicle (not shown) is moving into a visual range of the display device. In addition, a control 105 for controlling the display device is provided, which controls the display device as a function of a determination result. Control 105 preferably is developed as external control server, which includes both determination device 103 and control 105. External in this case in particular denotes that the control server is not located within but outside of the vehicle.

FIG. 2 shows a flow chart of a method for operating a display device located on a road. In a step 201, it is determined when a vehicle is moving into a visual range of the display device. In a step 203, the display device then is controlled as a function of the result of the determination.

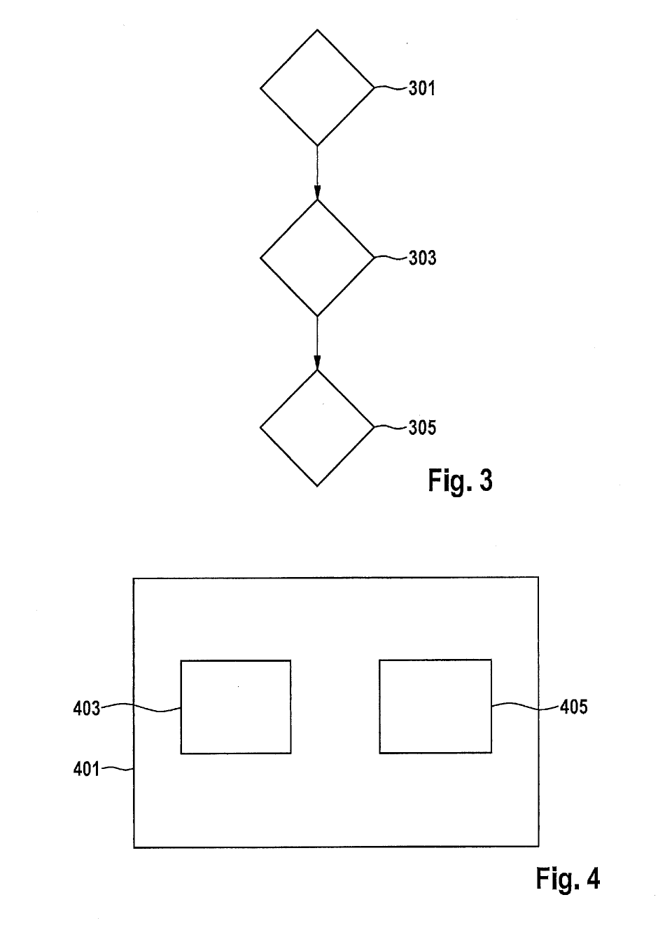

FIG. 3 shows a flow chart of another method for operating a display device located on a road. In a step 301, the current vehicle position and the current vehicle speed are transmitted from a vehicle to an external control server. In a step 303, the control server determines when the vehicle is moving into a visual range of the display device. At the determined instant at which the vehicle enters the visual range of the display device, the display device is activated in a step 305, so that it is able to display information, especially advertising, to the occupants of the vehicle. It may preferably be provided that the display device is activated already at a time prior to the determined instant at which the vehicle is entering the visual range of the display device. In particular, this advantageously makes it possible to ensure that the vehicle occupants are shown the information in a timely manner even if the vehicle accelerates in the meantime. In one specific embodiment (not shown) it may be the case that the vehicle transmits its scheduled route to the external control server.

FIG. 4 shows a vehicle system 401 for a vehicle (not illustrated). Vehicle system 401 includes a transmitter 403, which is able to transmit a vehicle position and a vehicle speed to an external control server. In addition, vehicle system 401 includes an optional identification device 405 for identifying vehicle passengers. In the process, the corresponding identification data of the vehicle passengers are also transmitted to the external control server by means of transmitter 403.

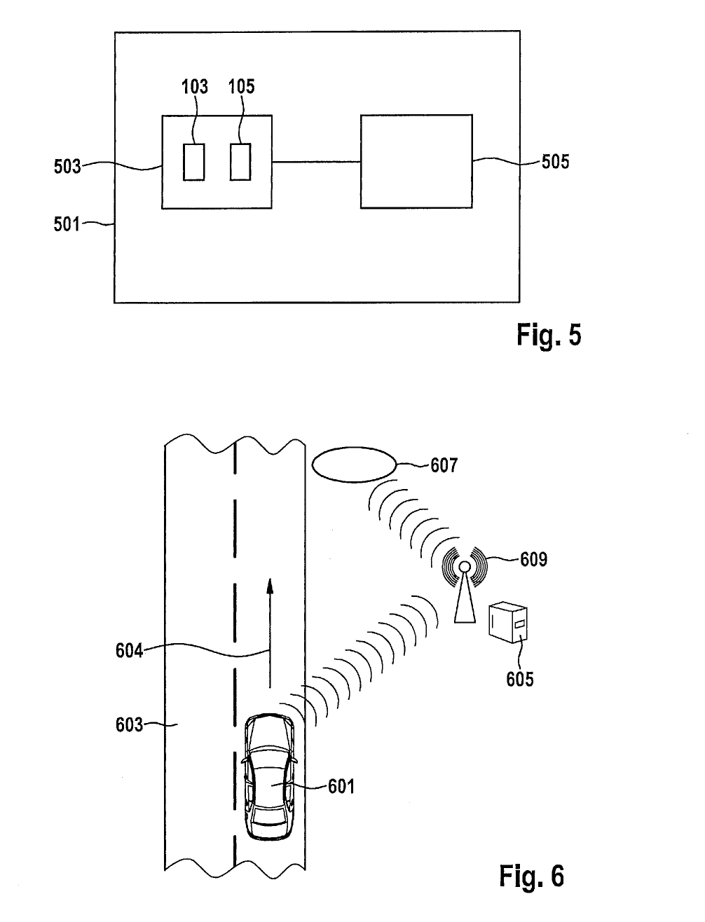

FIG. 5 shows a display system 501. Display system 501 includes a device 503 for operating a display device 505 located on a road. Control 105 of device 503 is used to control display device 505, this control being performed as a function of an instant at which a vehicle moves into a visual range of display device 501. The control of display device 505 may be carried out in wireless manner, in particular. In other words, corresponding control signals are transmitted to display device 505 wirelessly, in particular. However, it is also possible to provide a cabled communication between display device 505 and control 105. The communication may be encrypted, in particular.

FIG. 6 shows a vehicle 601 on a road 603. A driving direction of vehicle 601 is symbolically denoted by an arrow bearing reference numeral 604. Vehicle 601 includes a vehicle system (not shown). The vehicle system transmits the current vehicle position and the current vehicle speed to an external control server 605 including a determination device (not shown) and a control (not shown). It may preferably be the case that the vehicle system also transmits the scheduled driving route of the vehicle to external control server 605.

It could preferably be provided that the vehicle system transmits the number of vehicle occupants to external control server 605. Preferably, it may be the case that the vehicle system transmits the information as to which persons are sitting in which location in the vehicle to external control server 605. More specifically, the vehicle system may transmit information as to which vehicle passenger is looking out of which window of the vehicle to external control server 605. Furthermore, it may in particular be the case that the vehicle system transmits personal data of the vehicle passengers, i.e., vehicle-specific information, especially names and personal interests such as hobbies, for instance, to external control server 605. For example, it may be provided that the vehicle system sends vehicle-specific data, e.g., data concerning the vehicle, to external control server 605. Such vehicle-specific data, for example, may include a type of vehicle, especially whether it is a subcompact car or a luxury car, or a truck. Vehicle-specific data, for example, may also include a status of the vehicle, in particular, such as its age, condition, whether it has broken down, for example, whether repairs are required, and/or which fuel and/or which lubricants are required. Vehicle-specific data may in particular include a driving period and/or an attentiveness of the vehicle occupants, especially the driver, and, in particular, the information which vehicle occupants are thirsty and/or hungry and/or require a break.

Based on the transmitted vehicle position, current vehicle speed and possibly the scheduled driving route, external control server 605 determines when the vehicle will be passing a display device 607, i.e., in particular, when vehicle 601 will enter a visual range of display device 607. In addition, the external control server preferably determines further personal data of the vehicle occupants, such as interests, hobbies or purchases, provided the corresponding vehicle-specific data were previously transmitted to external control server 605 from an integrated database (not shown here) and/or from other accessible databases.

The communication between vehicle 601 and the control server, or between control server 605 and display device 607, preferably may take place in wireless manner, which is shown here exemplarily by the element provided with reference numeral 609. The communication may be carried out in encrypted manner, in particular.

In the process, control server 605 may then control device 607, preferably in such a way that it displays person-oriented advertising, i.e., specific to vehicle occupants, and advertising according to the following methodology.

If only one vehicle passenger is located in the vehicle, for example, selective, i.e., person-specific advertising, will be displayed for this person. In the event that multiple vehicle passengers are in the vehicle, then information or advertising for shared interests or possible purchases is displayed, if possible. Especially if vehicle 601 is not in an autonomous driving operating state, i.e., when vehicle 601 does not drive autonomously, then display device 607 preferably displays only information that is addressed to the passengers, but not the driver. External control server 605 thus transmits corresponding control signals to display device 607 for the control of display device 607, to specify which information, especially advertising, display device 607 is to display at which particular time.

In one specific embodiment, which is not shown, it may be the case that multiple vehicles 601 are located on road 603. Each of these various vehicles 601 transmits corresponding data and information to external control server 605. That is to say, if several vehicles 601 pass display device 607 at the same time, i.e., if these several vehicles 601 enter the visual range of display device 607 at the same instant, then the information, especially advertising, that is of interest to the majority of vehicle occupants now passing is able to be displayed on display device 607. However, an integration of the purchasing behavior of the vehicle passengers, i.e., weighting of the interests on the basis of, for example, how much income is at the disposal of the various vehicle passengers, and/or how much and what in particular the vehicle passengers are purchasing, may be taken into account as well.

1-13. (canceled)

14. A device for operating a display device located on a road, comprising:
a determination device for determining a time point when a vehicle moves into a visual range of the display device; and
a control for controlling the display device as a function of the determined time point when the vehicle moves into the visual range of the display device.

15. The device as recited in claim 14, wherein the determination device includes a detection device for detecting a vehicle position and a vehicle speed.

16. The device as recited in claim 15, wherein a database which includes person-specific information is provided in the device, and wherein the control is configured to control the display device as a function of the person-specific information.

17. The device as recited in claim 15, further comprising:
a transmitter for transmitting a vehicle position and a vehicle speed to the determination device in order to determine the time point.

18. The device as recited in claim 17, wherein the transmitter is configured to transmit a scheduled travel route of the vehicle to the determination device.

19. The device as recited in claim 17, further comprising:
an identification device for identifying a vehicle occupant, wherein the transmitter is configured to transmit identification data of the vehicle occupant to the control.

20. A method for operating a display device situated on a road, comprising:
determining a time point when a vehicle enters a visual range of the display device; and
controlling the display device as a function of the determined time point when the vehicle moves into the visual range of the display device.

21. The method as recited in claim 20, wherein the determination of the time point includes detecting a position of the vehicle and a speed of the vehicle.

22. The method as recited in claim 21, wherein the vehicle position and the vehicle speed are transmitted from the vehicle to a determination device for determining the time point.

23. The method as recited in claim 22, wherein a scheduled travel route of the vehicle is transmitted from the vehicle to the determination device.

24. The method as recited in claim 22, wherein information specific to at least one of the vehicle and a passenger of the vehicle is transmitted from the vehicle to a control device to control the display device as a function of the transmitted information.

25. A non-transitory computer-readable data storage medium storing a computer program having program codes which, when executed on a computer, perform a method for operating a display device situated on a road, the method comprising:
determining a time point when a vehicle enters a visual range of the display device; and
controlling the display device as a function of the determined time point when the vehicle moves into the visual range of the display device.
